(19) United States
(12) Patent Application Publication
(10) Pub. No.: US 2026/0129018 A1
(43) Pub. Date: May 7, 2026

(54) METHODS AND DEVICES FOR CONFIGURING A DNS MODULE AND FOR ADDRESS RESOLUTION IN ORDER TO MANAGE THE STREAMING OF MEDIA CONTENT IN A TELECOMMUNICATIONS NETWORK

(71) Applicant: Orange, Issy-les-Moulineaux (FR)

(72) Inventors: Elisabeth Lepoil, Chatillon (FR); Sylvain Chauvel, Chatillon (FR); Serge Rigaudeau, Chatillon (FR); Philippe Grave, Chatillon (FR)

(21) Appl. No.: 19/116,278

(22) PCT Filed: Sep. 26, 2023
(86) PCT No.: PCT/EP2023/076536

§ 371 Date: Mar. 27, 2025

(30) Foreign Application Priority Data
Sep. 28, 2022 (FR) FR2209817

(51) Int. Cl. H04L 61/4511; H04L 65/611; H04L 65/612

(52) U.S. Cl. CPC H04L 61/4511; H04L 65/611; H04L 65/612

(57) ABSTRACT

A method allows the configuration of a DNS module, the method implemented by an entity formed by a gateway configured to interconnect a local area network with an operator network or by a device of this local area network. The configuration includes registering a domain name which directs to a multicast gateway included in the entity and configured to respond to a content access request received over the local area network by unicasting this content, the content being received by the multicast gateway via multicasting from a multicast server for this content via the operator network, a rule for resolving a domain name of at least one content server with the IP address of a switching module located in the operator network, and registering a secondary domain name which directs to the content server. Upon receiving a request to access content the switching module responds with a redirect request to the domain name which directs to the multicast gateway if the content is to be accessed via multicasting, and with a redirect request to the secondary domain name which directs to the server for the content if the content is to be accessed via unicasting.

### BACKGROUND OF THE INVENTION

The present invention lies in the field of the management of the multimedia content stream broadcast in a telecommunications network. It particularly applies to the broadcasting of audiovisual contents of an OTT (Over the Top) service. These contents are proposed by means of a simple Internet connection and delivered in unicast streaming to a receiver (OTT set-top box) via the Web.

In a unicast broadcast mode, an emitter equipment (streaming server) generally belonging to a CDN (Content Delivery Network) emits a stream per client/receiver equipment (OTT set-top box) having requested the content (client mode/server). Consequently, if several clients access the same content simultaneously, for example the Live of a TV channel, several identical streams circulate in the network. This method has the disadvantage of occupying a significant bandwidth of the network in the event of significant simultaneous requests for a linear (live) service.

This unicast transmission is generally performed with contents prepared in ABR (Adaptive Bit Rate) or with adaptive bit rate in which the source content is encoded according to several bit rates, each segmented into small parts of several seconds, typically between two and ten seconds, the segments of the available streams and their respective bit rates being filled in a file downloadable by the clients (OTT set-top boxes). When a client starts receiving a stream, he generally requests the segments of the stream with the lowest bit rate and if he determines that the throughput of the network is higher than the throughput of the downloaded segment, he requests a higher throughput segment. Conversely, if a client finds that the throughput of the network has deteriorated, he can request a lower throughput segment. Each client implements an adaptive bit rate algorithm to decide which bit rate segments to download, depending on the current state of the network.

Historically, the linear stream broadcast used point-to-multipoint transmission methods such as Broadcast (cable, satellite, etc.) or Multicast (IPTV, etc.), these methods consisting in emitting a single stream to a plurality of receivers. These methods save bandwidth since in the network, a single stream circulates for all receivers. On the other hand, these methods required the use of receivers dedicated to the transmission mode (Satellite Receiver, IPTV set-top box, etc.) and to the characteristics of the transmission network (association of TV channel and broadcast frequency or multicast address, etc.), which is not compatible with OTT set-top boxes.

Since 2020, new standards have emerged such as M-ABR (e.g. DVB ETSI TS 103 769 V1.1.1 , a standard inspired by previous 3GGP and ATSC works) combining the encoding and packaging formats of the existing media (ABR) with the efficiency of the point-to-multipoint distribution up to the edge of the IP-based access networks. It becomes possible to design a linear media distribution system that is both efficient and scalable to very large audiences, while remaining technically compatible with the largest possible set of already deployed end-user equipment (OTT set-top boxes). Point-to-multipoint topologies also offer possibilities of efficient pre-positioning of the active users on the devices at the network edge. This supports additional non-linear use cases and can help mitigate the peak demand on the access network at the synchronization points in the linear schedule.

The invention particularly relates to a mechanism for routing the requests to access contents emitted by the client (OTT set-top box). In the DVB standard (DVB ETSI TS 103 769 V1.1.1 ), the device responsible for such a routing device is called appointment service. It makes it possible to redirect a request to access a content either towards a unicast CDN server (the classic mode), or towards a “multicast gateway”. The multicast gateway receives the contents via a multicast transport (see broadcast) and delivers them to the client in unicast.

FIG. 1 represents a first method for managing the multimedia stream broadcast in unicast towards an OTT receiver, this method being in accordance with the state of the art.

An OTT receiver device (OTT end device) includes an application CP_APP from a content provider (Content Provider Application), a multimedia stream set-top box and a DNS (Domain Name Server) module referenced DNS_OTT.

This receiver device OTT is connected by a local area network LAN to a home gateway HGW (Home Gateway). This home gateway HGW includes a DNS module, referenced DNS_HGW.

The home gateway HGW is connected to a telecommunications network NET including a DNS server DNS_NET.

A content server (Content Provider Server or CP server) CP_SRV from a content delivery network (CDN) is connected to the network NET. “CP.net” refers to the domain name (FQDN, Fully Qualified Domain Name) and “@IP_CDN” refers to the IP address of the content provider server CP_SRV.

In this document, the domain names are actually fully qualified domain names, the term domain name is used for the sake of simplicity.

When the user of the receiver device OTT wishes to access the content delivered by the content provider server CP_SRV, the device OTT sends (step 1E10) a “RESOLVE CP.net” request to resolve the domain name FQDN of this server.

This request is received by the DNS module DNS_OTT of the receiver device OTT and if this module cannot resolve the request (that is to say if it has never processed a similar request or if the response it holds has become obsolete), it transfers the request to the next DNS module for resolution, i.e. to the DNS_HGW of the home gateway HGW. On this same principle, if this module DNS_HGW cannot resolve the request, it transmits it to the next DNS server that is to say in this example to the DNS server DNS_NET of the network.

The DNS server DNS_NET of the network returns (step 1E20) the IP address @IP_CDN of the content delivery CP to the DNS module that queried it, that is to say to the DNS module DNS_HGW, and this is repeated up to the receiver device OTT.

The receiver device OTT sends (step 1E30) a “GET CP.net/content” request to the IP address @IP_CDN to obtain (step 1E40) the content of the content provider server CP_SRV in unicast mode.

FIG. 2 represents a second method for managing the broadcast of multimedia streams in accordance with the state of the art and particularly illustrates three additional functional modules for delivering to the receiver device OTT a content in multicast ABR M-ABR (for example in accordance with the DVB reference architecture ETSI TS 103 769 V1.1.1).

A “Multicast server” (MC_SRV) module, or “multicast server”, retrieves from the content broadcast server CP_SRV, the contents (step 2E70) to be emitted and broadcasts them in point-to-multipoint mode (step 2E80). In accordance with the M-ABR protocol, the broadcast mode is carried out in multicast.

An “Appointment Service” (RDV) module has knowledge of the contents broadcast in M-ABR. The application CP_APP of the receiver device PTT addresses the RDV module to obtain a content from the content provider server CP_SRV (step 2E90).

In one particular “REDIRECT” embodiment described here, the appointment service RDV module responds to the application CP_APP (steps 2E101 and 2E102) to directly search for the desired content in unicast on the Multicast Gateway (steps 2E112 and 2E122) or on the server CP_SRV (steps 2E111 and 2E121).

A multicast broadcast gateway (module MC_GW) has the role of retrieving the requested content (step 2E112) broadcast in multicast (in the case of M-ABR). For this purpose, the multicast broadcast gateway MC_GW subscribes to the corresponding multicast stream (step 2E80) and transmits it to the application CP_APP in step 2E122.

FIG. 3 represents a method for managing the multimedia stream broadcast in M-ABR mode in accordance with the state of the art in which:
the multicast server MC_SRV and the appointment service RDV module are located in the network NET of the operator; and
the multicast gateway MC_GW is integrated into the domestic gateway HGW.

As is known, the multicast server MC_SRV uses point-to-multipoint broadcast resources (step 3E02) made available by the network operator (in the context of the M-ABR, these resources are multicast IP addresses) and retrieves the contents to be broadcast in M-ABR (step 3E01) at the content provider server CP_SRV.

The appointment service RDV module must also have knowledge of the contents broadcast in M-ABR and the multicast broadcast gateway MC_GW knows the association between the content(s) broadcast in M-ABR and the point-to-multipoint broadcast resource(s) used carried out at the multicast server MC_SRV.

In this example, during the activation of the RDV module in the network, the network operator declares two new rules (step 3E03) in the DNS network (DNS_NET):
the first rule (CP.net=>@IP_RDV) redefines the resolution of the main FQDN “CP.net” either by the IP address @IP_RDV of the RDV module (in replacement of the IP address of the content broadcast server CP_SRV). As a variant not represented here, the main FQDN “CP.net” can be resolved by a new FQDN “RDV.net” which is resolved by the IP address of the RDV module;
the second rule (CPBIS.net=>@IP_CDN) defines a secondary FQDN “CPBIS.net” resolved by the IP address @IP_CDN of the content provider server CP_SRV.

Moreover, at the home gateway HGW, during the activation of the multicast broadcast gateway MC_GW, a new DNS rule (MC_GW.lan=>@IP_MC_GW) is inserted (step 3E05) in the DNS DNS_HGW of the home gateway HGW resolving the URL “MC_GW.lan” by the IP address @IP_MC_GW of the multicast broadcast gateway.

During a step 3E04, the multicast broadcast gateway MC_GW registers in a database at the appointment service RDV module. Thus, when a device requests the appointment service RDV module via this home gateway HGW, the appointment service RDV module knows whether a multicast broadcast gateway MC_GW is present for this device.

In the example of FIG. 3, when the application CP_APP of the receiver device OTT resolves the domain name “CP.net”, it obtains the IP address @IP_RDV of the appointment service RDV module (steps 3E10, 3E20), thus its content request (step 3E30) is redirected towards the RDV module.

The appointment service RDV module performs a routing function. Indeed, the response to the content request is a request to redirect the request towards the FQDN “MC_GW.lan” (step 3E42) if, on the one hand, the multicast broadcast gateway MC_GW has been registered on the appointment service RDV module and if, on the other hand, the content is broadcast in M-ABR mode. This response, once resolved (steps 3E52 and 3E62) allows the receiver device OTT to obtain the content of the multicast broadcast gateway MC_GW (steps 3E72, 3E82 and 3E92).

On the contrary, if the multicast broadcast gateway MC_GW has not been registered in the database, or if the requested content is not broadcast in M-ABR mode; the response to the content request (3E30) is a request for redirection towards the secondary FQDN “CPBIS.net” which once resolved (steps 3E51 and 3E61) will allow obtaining the content of the content provider server CP_SRV (steps 3E71 and 3E81).

It is important to note that this broadcast method has a major drawback in that it requires declaring (in step 3E04) the multicast broadcast gateway MC_GW with the appointment service RDV module.

Indeed, assuming that this registration is not carried out, and therefore that the appointment service module systematically returns, in step 3E42, as soon as the requested content is accessible in multicast, a redirection instruction towards a domain name associated with a multicast broadcast gateway, even in the absence of such a gateway MC-GW, then step 3E52 of resolving this domain name would result in a service interruption, typically an HTTP code 404 error. To avoid such an inconvenience, a known solution consists in managing such a response at the application CP_APP of the OTT set-top box to redirect the request towards the content provider server CP_SRV for unicast receipt.

This solution is not satisfactory in that it requires a modification of the software of the OTT receivers.

The invention aims a broadcasting method that does not have these drawbacks.

### OBJECT AND SUMMARY OF THE INVENTION

Thus, and according to a first aspect, the invention concerns a method for configuring a DNS module implemented by a home gateway configured to interconnect a local area network with an operator network, said configuration including at least:
(i) a registration of a domain name pointing to a multicast gateway comprised in said home gateway and configured to respond to a request to access a content received on the local area network, by sending this content in unicast, said content being received in multicast by the multicast gateway from a multicast server of this content via the network of the operator;
(ii) a rule for resolving a domain name of at least one content provider server with the address of a routing module located in the network of the operator,
said routing module being configured, upon receipt of a request to access a content, to:
   respond with a request for redirection towards said domain name pointing to said multicast gateway if the content is to be accessed in multicast; and
   respond with a request for redirection towards a secondary domain name resolvable to the address of the server of said content if the content is to be accessed in unicast.

Correlatively, the invention concerns a device for configuring a DNS module comprised in a home gateway configured to interconnect a local area network with an operator network, said configuration including with at least:
(i) a registration of a domain name pointing to a multicast gateway comprised in said home gateway and configured to respond to a request to access a content received on the local area network, by sending this content in unicast, said content being received in multicast by the multicast gateway from a multicast server of this content via the network of the operator;
(ii) a rule for resolving a domain name of at least one content provider server with the IP address of a routing module located in the network of the operator,
said routing module being configured, upon receipt of a request to access a content, to:
   respond with a request for redirection towards the domain name pointing to said multicast gateway if the content is to be accessed in multicast; and
   respond with a request for redirection towards a secondary domain name resolvable to the address of said content provider server if the content is to be accessed in unicast.

The method for configuring a DNS module according to the invention is remarkable in that it makes it possible to intelligently route the stream in unicast or multicast towards the OTT receiver according to the broadcast mode of this stream, without requiring prior registration or declaration of the multicast broadcast gateway within the appointment service module, or modification of the software of the OTT receivers.

The invention also relates to an address resolution device configured by the configuration method mentioned above and an address resolution method implemented by such a device.

Thus, according to a second aspect, the invention concerns an address resolution method implemented by an entity constituted by a home gateway configured to interconnect a local area network with an operator network, this method including:
a step of receiving a request to resolve a domain name from a content provider server,
a step of responding to said resolution request by sending the IP address of a routing module located in the network of the operator,
said routing module being configured, upon receipt of a request to access a content, to:
   respond with a request for redirection towards a domain name of a multicast gateway comprised in said home gateway if the content is to be accessed in multicast; and
   respond with a request for redirection towards a secondary domain name resolvable to the address of a server of said content if the content is to be accessed in unicast.

Correlatively, the invention concerns an address resolution device intended to be integrated into a home gateway configured to interconnect a local area network with an operator network, this device including:
a module for receiving a request to resolve a domain name from a content provider server; and
a module for sending a response to said resolution request, said response including the IP address of a routing module located in the network of the operator,
said routing module being configured, upon receipt of a request to access a content, to:
   respond with a request for redirection towards the domain name of a multicast gateway comprised in said home gateway if the content is to be accessed in multicast; and
   respond with a request for redirection towards a secondary domain name resolvable to the address of a server of said content if the content is to be accessed in unicast.

The invention also concerns a home gateway configured to interconnect a local area network with an operator network, this gateway being characterized in that it includes a configuration device as mentioned above.

The invention also concerns a multicast gateway integrated into a home gateway as mentioned above and configured to respond to a request to access a content by sending this content in unicast, this content being received by said multicast gateway in multicast from a multicast broadcast server of this content, said multicast gateway including a configuration device as mentioned above.

In one embodiment of the invention, the configuration method is implemented upon detection of the presence of the multicast gateway. In this embodiment, as soon as the home gateway detects the presence of the broadcast gateway, it configures its DNS with the two rules (i) and (ii) mentioned above.

In one embodiment, the configuration method is implemented by the multicast gateway, preferably as soon as it starts. In this embodiment, it is the multicast gateway that itself configures the DNS of the home gateway with the two rules (i) and (ii) mentioned above.

In one particular embodiment, the different steps of the configuration method and/or of the address resolution method are determined by computer program instructions or are implemented by a silicon chip that comprises transistors adapted to constitute logic gates of a non-programmable hardwired logic.

Consequently, the invention also relates to a computer program on an information medium, this program being capable of being implemented in a controller computer, this program including instructions adapted to the implementation of the steps of a configuration and/or address resolution method as described above.

This program can use any programming language, and be in the form of source code, object code, or intermediate code between source code and object code, such as in a partially compiled form, or in any other desirable form.

The invention also relates to a computer-readable information medium, and including instructions of a computer program as mentioned above. The information medium can be any entity or device capable of storing the program. For example, the medium can include a storage means, such as a ROM, a non-volatile memory of the flash type or a magnetic recording means, for example a hard disk. On the other hand, the information medium can be a transmissible medium such as an electrical or optical signal, which can be conveyed via an electrical or optical cable, by radio or by other means. The program according to the invention can be particularly downloaded from an Internet-type network. Alternatively, the information medium can be an integrated circuit into which the program is incorporated, the circuit being adapted to execute or to be used in the execution of the method in question.

### BRIEF DESCRIPTION OF THE DRAWINGS

Other characteristics and advantages of the present invention will emerge from the description given below, with reference to the appended drawings which illustrate exemplary embodiments without any limitation. In the figures:

FIG. 1, already described, represents a method for managing the multimedia stream broadcast in unicast in accordance with the state of the art;

FIG. 2, already described, represents another method for managing the multimedia stream broadcast in accordance with the state of the art;

FIG. 3, already described, represents another method for managing the multimedia stream broadcast in accordance with the state of the art;

FIG. 4 represents a configuration method and an address resolution method in accordance with one particular embodiment of the invention;

FIG. 5 represents a configuration device in accordance with one particular embodiment of the invention;

FIG. 6 represents an address resolution device in accordance with one particular embodiment of the invention; and

FIG. 7 represents a home gateway and a multicast gateway in accordance with one particular embodiment of the invention.

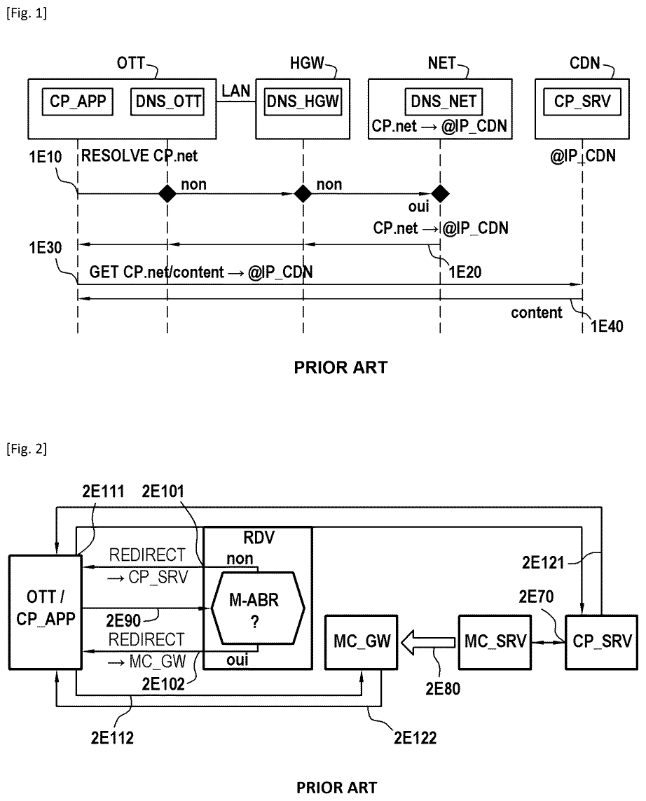

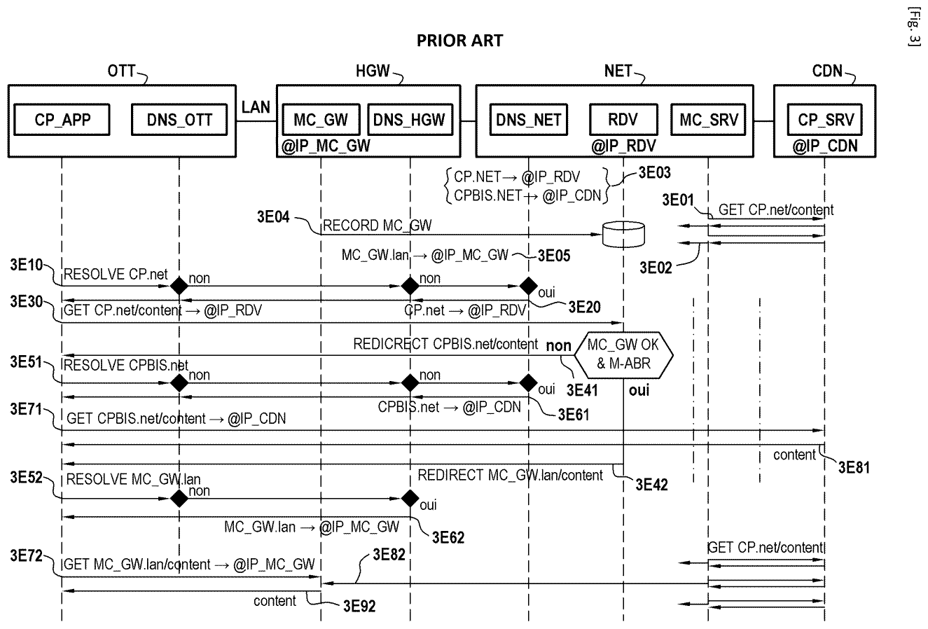

### DETAILED DESCRIPTION

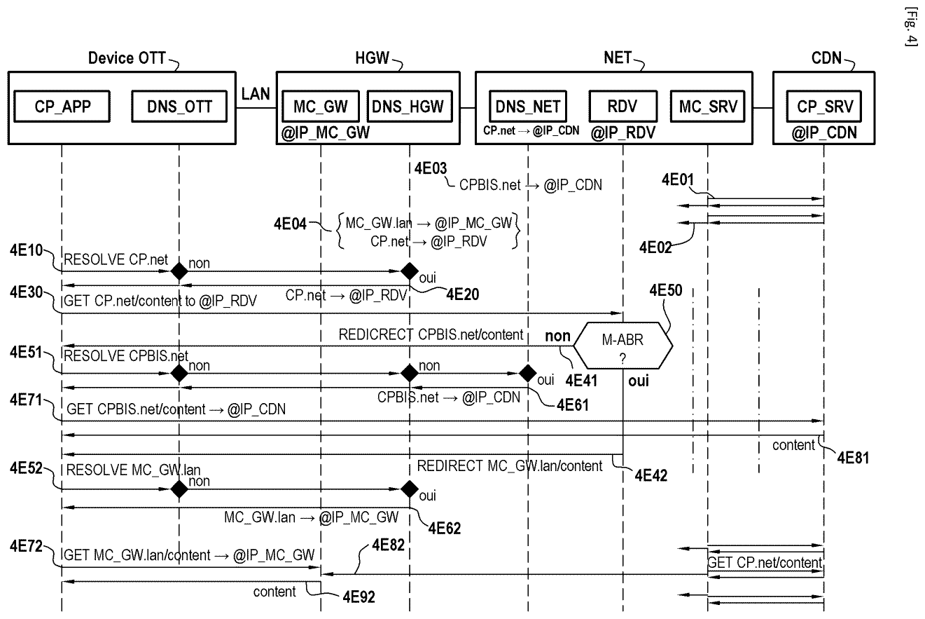

FIG. 4 represents a method for configuring a DNS module and an address resolution method in accordance with one particular embodiment of the invention.

In this embodiment, the configuration method and the address resolution method are implemented by a home gateway HGW making the interconnection between a local area network LAN and an operator network NET.

In this embodiment, the home gateway HGW includes a DNS module DNS_HGW and a multicast gateway MC_GW.

FIG. 4 represents a content provider server CP_SRV of a content delivery network CDN connected to the network NET. “CP.net” refers to the domain name FQDN and “@IP_CDN” refers to the IP address of the content provider server CP_SRV.

FIG. 4 represents an OTT receiver device including an application CP_APP of a content provider, a set-top box (not represented) and a DNS module DNS_OTT.

A multicast server MC_SRV of the network NET of the operator uses point-to-multipoint broadcast resources (step 4E02) and retrieves the contents to be broadcast in M-ABR mode (step 4E01) at the content provider server CP_SRV.

A RDV routing module ensuring an appointment service function is installed in the network NET of the operator.

In the embodiment described here, during a step 4E03, during the activation of the RDV routing module in the network, the network operator declares a new rule in the DNS network DNS_NET (CPBIS.net=>@IP_CDN) which defines a secondary FQDN “CPBIS.net” resolved by the IP address @IP_CDN of the content provider server CP_SRV.

During a step 4E04, a controller CTR of the home gateway HGW detects the presence of the multicast gateway MC_GW.

During this same step 4E04, the controller CTR configures the DNS module DNS_HGW of the home gateway. More specifically:
it registers a domain name MC_GW.lan pointing to the multicast gateway MC_GW. Since the multicast gateway MC_GW is comprised in the home gateway HGW, the multicast gateway MC_GW and the home gateway HGW have the same IP address, which is the IP address @IP_MC_GW;
it registers a rule (CP.net=>@IP_RDV) that redefines the resolution of the main FQDN “CP.net” of the content provider server CP_SRV by the IP address @IP_RDV of a RDV routing module located in the network of the operator.

During a step 4E10, the OTT receiver device sends a request RESOLVE CP.net to resolve the main domain name of the content provider server CP_SRV.

This request is received by the DNS module DNS_OTT of the OTT receiver device and transferred to the DNS module DNS_HGW of the home gateway.

The DNS module DNS_HGW of the home gateway responds (step 4E20) to the OTT receiver device that the IP address of the content provider server CP_SRV is the IP address @IP_RDV of the RDV routing module.

The OTT receiver device sends (step 4E30) a request to access a GET content CP.net/content to the IP address @IP_RDV of the RDV routing module.

During a step 4E50, the RDV routing module determines whether the URL associated with the content is, in a configuration file, associated with an ABR multicast broadcast mode.

If this is the case, the RDV routing module sends (step 4E42) to the OTT receiver device a redirection request REDIRECT MC_GW.lan/content so that it sends its request to access the content to the multicast gateway MC_GW.

During a step 4E52, the OTT receiver device sends a request “RESOLVE MC_GW.lan” to resolve the FQDN domain name of the multicast gateway MC_GW.

This request is received by the DNS module DNS_OTT of the OTT receiver device and transferred to the DNS module DNS_HGW of the home gateway HGW.

The home gateway HGW returns (step 4E62) to the OTT receiver device the IP address @IP_MC_GW of the multicast gateway MC_GW. This is also the IP address of the home gateway HGW.

The OTT receiver device sends (step 4E72) the request “GET MC_GW.lan/content” to access the content to the IP address of the multicast gateway MC_GW.

This multicast gateway MC_GW ensures the conversion, in unicast for restitution by the OTT receiver device, of the stream received in multicast from the multicast broadcast server MC_SRV.

The multicast gateway MC_GW sends (step 4E92) in unicast to the set-top box DEC, the content received (4E82) in multicast from the multicast broadcast server MC_SRV.

If, during step 4E50, the RDV routing module determines that the URL associated with the content is not associated with an ABR multicast broadcast mode, the RDV routing module sends (step 4E41) to the OTT receiver device a request for redirection REDIRECT CPBIS.net/content towards the secondary FQDN of the content provider server CP_SRV.

During a step 4E51, the OTT receiver device sends a request “RESOLVE CPBIS.net” to resolve the secondary FQDN domain name of the unicast content provider server CP_SRV.

This request is received by the DNS module DNS_OTT of the OTT receiver device and transferred to the DNS module DNS_HGW of the home gateway HGW, which transfers it to the DNS module DNS_NET of the operator.

The module DNS_NET of the operator returns (step 4E61) to the OTT receiver device the IP address @IP_CDN of the unicast content provider server CP_SRV.

The OTT receiver device sends (step 4E71) the request “GET CPBIS.net/content” to access the content to the IP address IP_CDN of the unicast content provider server CP_SRV.

The unicast content provider server CP_SRV sends the content to the OTT receiver device during a step 4E81.

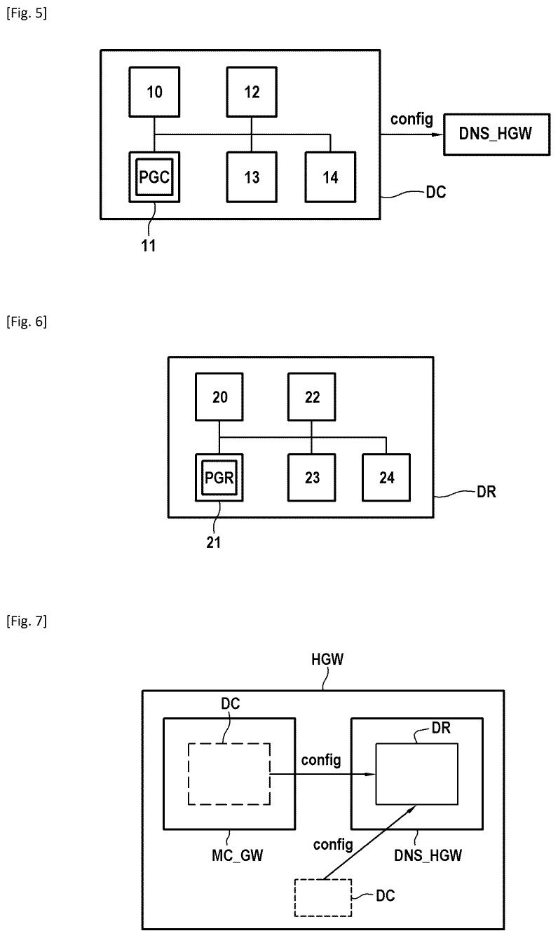

FIG. 5 represents a device DC for configuring a module in accordance with the invention. This device is intended to be integrated into a home gateway HGW between a local area network and an operator network NET, the home gateway HGW including a multicast gateway MC_GW.

In the embodiment described here, the configuration device DC has the hardware architecture of a computer. It includes a processor 10, a read-only memory ROM 11, a random access memory 12, a rewritable non-volatile memory 14 and communication means 15.

The read-only memory ROM 11 constitutes a recording medium within the meaning of the invention. It includes a computer program PGC including instructions for the execution of the steps of a configuration method in accordance with the invention when this program is executed by the processor 10.

Particularly, the communication means 15 are configured to configure a DNS module DNS_HGW with configuration rules including at least:
(i) a registration of a domain name MC_GW.fr pointing to the multicast gateway MC_GW;
(ii) a rule for resolving a domain name CP.net of at least one content provider server CP_SRV with the IP address @IP_RDV of an RDV routing module located in the network NET of the operator,
FIG. 6 represents an address resolution device DR in accordance with the invention. This device is intended to be integrated into a domestic gateway HGW between a local area network and a network NET of the operator.

In the embodiment described here, the address resolution device DR has the hardware architecture of a computer. It includes a processor 20, a read-only memory ROM 21, a random access memory 22, a rewritable non-volatile memory 24 and communication means 25.

The read-only memory ROM 21 constitutes a recording medium within the meaning of the invention. It includes a computer program PGR including instructions for the execution of the steps of an address resolution method in accordance with the invention when this program is executed by the processor 20.

The communication means 25 are in particular configured to receive a request to resolve a domain name from a content provider server and to send, in response to this resolution request, a response including the IP address of an RDV routing module located in the network of the operator, this RDV routing module being configured, upon receipt of a request to access a content, to:
respond with a request for redirection towards a domain name of a multicast gateway comprised in the home gateway if the content is to be accessed in multicast; and
respond with a request for redirection towards a secondary domain name that can be resolved to the address of a server of the content if the content is to be accessed in unicast.

FIG. 7 represents a home gateway HGW and a multicast gateway MC_GW in accordance with the invention.

The home gateway HGW includes a DNS module DNS-HGW, a configuration device DC and an address resolution device DR in accordance with the invention.

In one embodiment, the configuration device DC is integrated into the multicast gateway MC_GW. The multicast gateway is then in accordance with the invention.

In another embodiment, the configuration device DC of the home gateway HGW is not integrated into the multicast gateway MC_GW.

In one embodiment, the address resolution device DR is integrated into the DNS module DNS_HGW.

1. A method for configuring a DNS module implemented by a home gateway configured to interconnect a local area network with an operator network, said configuration including at least:
(i) a registration of a domain name pointing to a multicast gateway comprised in said home gateway and configured to respond to a request to access a content received on the local area network, by sending this content in unicast, said content being received in multicast by the multicast gateway from a multicast server of this content via the operator network; and
(ii) a rule for resolving a domain name of at least one content provider server with an IP address of a routing module located in the network (NET) of the operator,
said routing module being configured, upon receipt of a request to access a content, to:
respond with a request for redirection towards said domain name pointing to said multicast gateway if the content is to be accessed in multicast; and
respond with a request for redirection towards a secondary domain name resolvable to an address of said content provider server if the content is to be accessed in unicast.

2. The method of claim 1, said method being implemented upon detection of presence of the multicast gateway.

3. The method of claim 1, said method being implemented by the multicast gateway.

4. An address resolution method implemented by a home gateway configured to interconnect a local area network with an operator network, said method including:
receiving a request to resolve a domain name from a content provider server; and
responding to said resolution request by sending an IP address of a routing module located in the network of the operator,
said routing module being configured, upon receipt of a request to access a content, to:
respond with a request for redirection towards a domain name of a multicast gateway comprised in said home gateway if the content is to be accessed in multicast; and
respond with a request for redirection towards a secondary domain name resolvable to an address of a server of said content if the content is to be accessed in unicast.

5. A device for configuring a DNS module comprised in a home gateway configured to interconnect a local area network with an operator network, said configuration including at least:
(i) a registration of a domain name pointing to a multicast gateway comprised in said home gateway and configured to respond to a request to access a content received on the local area network, by sending this content in unicast, said content being received in multicast by the multicast gateway from a broadcast server of this content via the operator network; and
(ii) a rule for resolving a domain name of at least one content provider server with an IP address of a routing module located in the operator network,
said routing module being configured, upon receipt of a request to access a content, to:
respond with a request for redirection towards the domain name pointing to said multicast gateway if the content is to be accessed in multicast; and
respond with a request for redirection towards a secondary domain name resolvable to an address of said content provider server if the content is to be accessed in unicast.

6. A home gateway configured to interconnect a local area network (LAN) with an operator network (NET), said home gateway comprising the device of claim 5.

7. A multicast gateway integrated into the home gateway of claim 6 and configured to respond to a request to access a content by sending in unicast this content, this content being received by said multicast gateway in multicast from a multicast broadcast server of this content.

8. An address resolution device intended to be integrated into a home gateway configured to interconnect a local area network with an operator network, this device comprising a processor and configured to:
receive a request to resolve a domain name from a content provider server; and
send a response to said resolution request, said response including an IP address of a routing module located in the network of the operator,
said routing module being configured, upon receipt of a request to access a content, to:
respond with a request for redirection towards a domain name of a multicast gateway comprised in said home gateway if the content is to be accessed in multicast; and
respond with a request for redirection towards a secondary domain name resolvable to an address of a server of said content if the content is to be accessed in unicast.

9. A non-transitory computer readable medium having stored thereon instructions which, when executed by a processor, cause the processor to implement the method of claim 1.

10. A non-transitory computer readable medium having stored thereon instructions which, when executed by a processor, cause the processor to implement the method of claim 1.
